(19) United States
(12) Patent Application Publication
(10) Pub. No.: US 2010/0052277 A1
(43) Pub. Date: Mar. 4, 2010

(54) STROLLER ACCESSORY

(75) Inventor: Mark Zehfuss, Glen Allen, VA (US)

Correspondence Address: TROUTMAN SANDERS LLP;BANK OF AMERICA PLAZA, 600 PEACHTREE STREET, N.E., SUITE 5200, ATLANTA, GA, 30308-2216, US

(73) Assignee: Dynamic Brands, LLC, Richmond, VA (US)

(21) Appl. No.: 12/549,788

(22) Filed: Aug. 28, 2009

Related U.S. Application Data
(60) Provisional application No. 61/190,973, filed on Sep. 4, 2008.

(51) Int. Cl. B62B 9/12; F16M 13/02; B62B 7/04

(52) U.S. Cl. 280/47.35; 248/226.11

(57) ABSTRACT

A stroller accessory is described. The stroller accessory is capable of supporting a seat on the stroller. The seat may be a baby seat, a baby carrier, or an infant car seat, for example. The accessory allows the seat to be moved from a first position to a second position. In a preferred embodiment, the stroller is a double stroller in a side-by-side configuration and allows the seat to be moved from a position over one of the seats of the double stroller to a position in a central portion of the double stroller.

### RELATED APPLICATIONS

This U.S. patent application claims priority to U.S. Provisional Patent Application Ser. No. 61/190,973 filed on Sep. 4, 2008 and is hereby incorporated by reference in its entirety.

### TECHNICAL FIELD

The invention is directed to accessories for a stroller. More specifically, embodiments of the invention are directed to a stroller accessory for supporting a seat such as, but not limited to, a baby seat, a car seat or a baby carrier on a stroller. The accessory of the invention is particularly useful for safely supporting a seat on a double stroller.

### BACKGROUND

Parents with multiple young children may have difficulty transporting them. Further, children may lag behind their parents trying to complete shopping tasks or get exercise. Many parents have purchased double strollers allowing the parent or other guardian to push two children simultaneously and to more efficiently run errands, take walks, or jog. As such, a double stroller allows the parents or guardians more freedom than they would have with a single stroller, especially while trying to carry two sleeping children.

Parents with children of different ages, such as a toddler and infant, have additional difficulties. The younger child may not be sufficiently old enough to support themselves in the seat of a typical double stroller or may be sleeping in a different seat such as, but not limited to, a baby seat, a baby carrier or car seat, for example. For example, after driving to a destination, the parent or other guardian may wish to transfer a baby in a car seat from the car to a stroller without waking or otherwise disturbing the baby. Various stroller manufacturers have addressed this concern by providing support means for a car seat to be secured in a stroller. This allows the parent or guardian to lift the car seat and the baby out of the car and secure the baby in the stroller without removing them from the car seat and, hopefully, without disturbing them. This solves significant problems for the parent.

This can be particularly advantageous for parents with children of different ages. An infant in the car seat can be transferred and secured in one seat of the double stroller and another child may be seated and secured in the other seat. In this case, with both seats of the double stroller occupied, the double stroller is substantially balanced and may safely be used to transport both children. However, if the older child gets out of the double stroller, only the car seat and baby remain in the double stroller. This may result in a weight imbalance and safety problem. With only one seat occupied, there is an increased risk that the stroller will tip causing injury to the baby. Parents attempt to adjust the balance of the stroller by placing shopping bags or other objects in the empty seat of the double stroller or merely by applying increased force on the opposite side to balance the stroller. However, neither of these methods is convenient or safe.

There exists a need for a double stroller that can accommodate a baby seat and remain stable under various conditions of use. There is also a need for an accessory for a double stroller that accommodates a baby seat in multiple positions on a stroller, such as on a double stroller. There is a further need for an accessory for a double stroller that is capable of accommodating a seat and allowing the seat to be placed in a first position allowing access to another seat of the stroller and a second position in a central portion of the stroller.

### SUMMARY OF THE INVENTION

The invention relates to a stroller accessory. The stroller accessory is capable of supporting a seat on the stroller. The seat may be a baby seat, a baby carrier, or an infant car seat, for example. Embodiments of the accessory of the invention allow the seat to be moved from a first position to a second position on the stroller. In a preferred embodiment, the stroller is a double stroller with a side-by-side configuration double stroller and the accessory allows the seat to be moved from a position over one of the seats of the double stroller to a position in a central portion of the double stroller. With the seat in the central position, the double stroller is more evenly balanced if only one child is in the stroller. In another embodiment, the stroller accessory comprises at least one attachment member and a seat attachment portion capable of supporting a seat. Further, the attachment member may comprise at least one clamp for attaching the attachment member to a frame of a stroller, in preferred embodiments, the attachment member comprises two clamps for attaching the attachment member to a stroller.

In embodiments of the stroller accessory, the seat attachment portion is slidingly attached to the attachment member of the accessory. Further, the stroller accessory may comprise a seat attachment portion, wherein the seat attachment portion is capable of supporting a seat such that the center of balance of the seat may be moved to a more central portion of the stroller. In any embodiment of the stroller accessory, the seat may be removably attached to the seat attachment member. In further embodiments, the stroller accessory may be integral to the frame of the double stroller. In such an embodiment, the frame of the double stroller may comprise a frame member and a seat attachment portion capable of supporting a seat, wherein the seat attachment portion may be positioned in at least a first position and a second position on the frame member.

### BRIEF DESCRIPTION OF THE FIGURES

FIG. 1 shows an embodiment of a double stroller;

FIG. 2 shows another embodiment of a double stroller;

FIG. 3 shows an embodiment of an accessory capable of accommodating a baby seat in a double stroller such as the embodiments of the double strollers shown in FIGS. 1 and 2; and

FIG. 4 shows another embodiment of an accessory capable of accommodating a baby seat in a double stroller such as the embodiments of the double strollers shown in FIGS. 1 and 2.

### DESCRIPTION

The invention relates to an accessory, attachment, or frame for a stroller. The accessory, attachment, or frame for the stroller is capable of supporting a seat such as, but not limited to, a baby seat, a bassinet, a baby carrier, or a car seat, for example, on the stroller. In embodiments of the accessory, the attachment, or frame is capable of supporting a baby seat in at least two different positions. In certain embodiments, the seat attachment member may be moved from a first position over or to a new seat portion of the double stroller to a central portion of the double stroller. In the central portion, the double stroller may e in a more balanced configuration especially if only one child is occupying the double stroller. Embodiments of the invention are particularly useful for a double stroller. As used herein, a double stroller is a stroller that has two or more seats for carrying two or more children simultaneously.

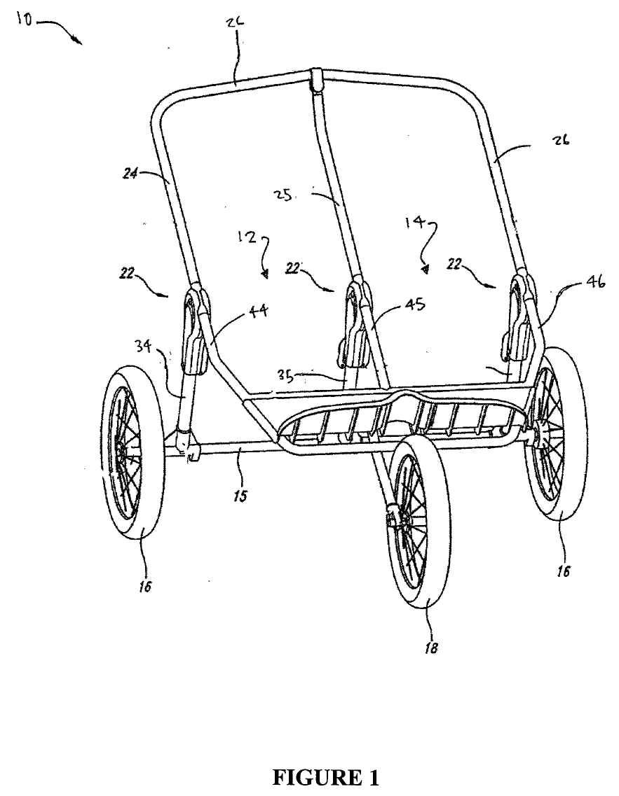

There are various types of double strollers. Typically, the seats of a double stroller may be side-by-side configuration or may be one seat in front of the other. Each type of double stroller has certain advantages. An example of a frame of a double stroller with side-by-side seats is shown in FIG. 1. The embodiment of the frame of a double stroller 10 of FIG. 1 is an example of an “all-terrain” baby stroller. An all-terrain baby stroller comprises a stronger frame and bigger tires than a typical baby stroller. Embodiments of the accessory are not limited to all terrain strollers but may be used on any side-by-side double stroller design. The seats of the double stroller 10 would be between the frame members at locations 12 and 14. As can be seen, if both seats of the double stroller are occupied, the stroller is in a relatively balanced position with an even distribution of weight across the width of the stroller, assuming both children are of reasonably similar weight. This is true even if a car seat is supported on one seat and a child occupies the other seat. Double strollers are designed to be able to handle children of reasonably different weights in each seat. However, since the child in the car seat is elevated higher than a child would be if sitting directly in the stroller seat, the center gravity of the stroller and child is higher above the ground and the stroller may be more easily tipped than a more evenly balanced stroller. This problem is made worse if there is no child in the second seat to balance the weight of a child in a car seat in one seat. Embodiments of the accessory of the invention allow a seat in a double stroller to be moved to a central portion of the stroller to more centrally distribute the weight.

The frame 12 of the stroller 10 comprises left upper frame member 24, center upper frame member 25, and right upper frame member 26. The upper frame members 24, 25, and 26 may be attached or integral with a handle 27 for holding and pushing the baby stroller 10. The baby stroller 10 also comprises left back wheel frame support 34, center back wheel frame support 35, and right back wheel frame support 36. In the embodiment of the double baby stroller 10, the back wheel frame supports 34, 35 and 36 may be attached or formed integral to an axle 15. Axle 15 extends the width of the baby stroller 10 and is connected to two rear wheels 16. The entire width of the baby stroller 10 is measured from the outside of each of the near wheels 16 and the centerline is midway between the outside of these rear wheels 16 as viewed from the top or front of the stroller. For a tandem stroller, the length of the stroller may be measured from the front of a front wheel to the back of a rear wheel and the centerline intersects a midpoint between these two points.

The baby stroller 10 also comprises left front wheel frame support 44, center front wheel frame support 45, and right front wheel frame support 46. In the embodiment of the double baby stroller 10, the front wheel frame supports 44, 45 and 46 may be attached or formed integral to a front wheel fork 47 attached to a front wheel 18. The front wheel fork 47 may be fixedly attached or may be pivotally attached to the stroller frame.

Optionally, the baby stroller may comprise at least one folding mechanism 22. Folding mechanisms 22 allow the stroller to be folded to a smaller size for storage or transporting in an automobile by allowing both upper frame members 24, 25, and 26 and front wheel supports 44, 45, and 46 to be folded toward back wheel frame supports 34, 35 and 36. The embodiment of the baby stroller 10 comprises three folding mechanisms 22.

The embodiment of the stroller 10 is shown only as an example of one baby stroller, the frame of the double stroller may be any configuration. Embodiments of the accessory of the invention may be configured to be used on any such configuration of a stroller. For example, a different embodiment of the baby stroller may not include any center frame supports, may not include a folding mechanism or may only include one or two folding mechanisms. In addition, the baby stroller may include additional features not included in baby stroller 10. For example, optionally, a double stroller may include two front wheels, a pivotal front wheel fork or other means for allowing the front wheel to pivot, or an entirely different frame configuration. The stroller accessory may be integral or incapable of being securely and removably attached to the double stroller.

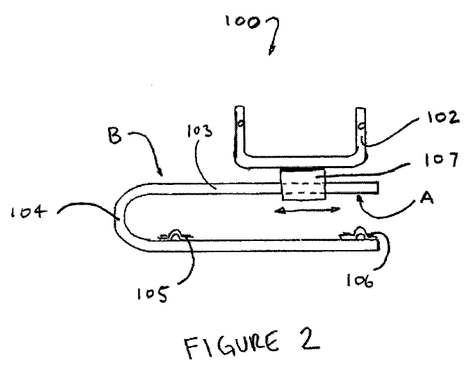

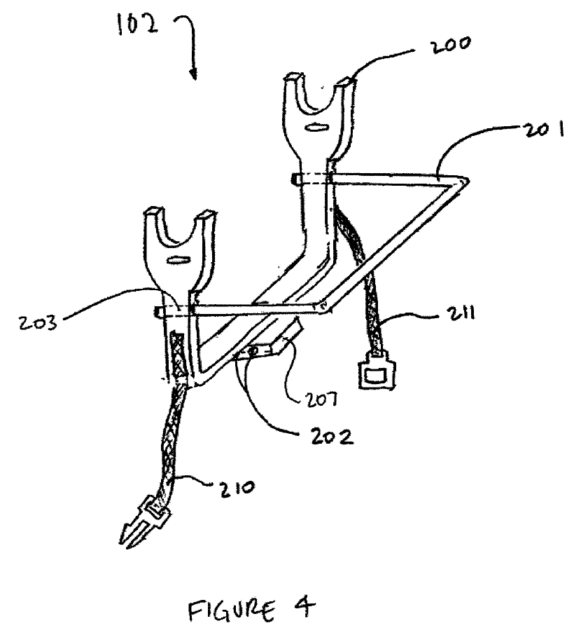

FIG. 2 shows an embodiment of a stroller accessory capable of supporting a seat on a stroller. Stroller accessory 100 comprises a seat attachment member 102 capable of supporting a seat such as a car seat. The seat attachment member may be designed and capable of supporting a single seat or capable of being used more universally such as the seat attachment member in FIG. 4. The seat may be selectively positioned in at least a first position A and a second position B on the accessory 100. The stroller accessory 102 may further comprise support 104. The attachment member 102 may be selectively positioned on the support 104 by any means. For example, the attachment member may be slidingly connected to the support 104, as shown in FIGS. 2, 3, and 4, or the support may have a plurality of fixed attachment points for releasably connecting the attachment member. The attachment member 102 may be permanently affixed to the accessory 100 or may be detachable. In embodiments of the accessory comprising a detachable attachment member 102, the accessory may be capable of being replaced with a second attachment member of a different design adapted to support a different child seat or other accessory.

In the embodiment of the stroller accessory 100 shown in FIG. 2, the attachment member 102 is slidingly connected to the support 104. An attachment support portion 103 is capable of supporting the seat attachment portion in multiple positions. The attachment support portion 103 may be of a solid or tubular construction and may be any shape including, but not limited to, a tubular member having a cross-sectional shape selected from circular, polygonal, square, rectangular, and triangular. The attachment support portion 103 may comprise multiple parts, for example, the attachment support portion 103 may comprise multiple tubular members to provide improved support for the seat attachment member 102. Attachment member 102 comprises a slide connector 107. The slide connector may be slidably connected to the attachment support portion 103. For example, the slide connector 107 may comprise a recess that is of a complementary shape to the shape of the attachment support portion 103. In this manner, the slide connector 107 may be slidingly attached to the attachment support number 103. In other embodiments, the slide connector 102 may be integral to the other portions of the attachment member 102.

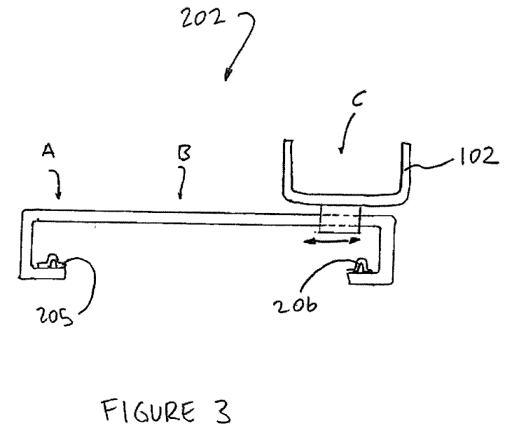

The accessory 100 may be secured to a stroller. For example, accessory 100 comprises two U-shaped brackets 105 and 106 for clamping to the frame of a stroller. For example, the accessory 100 may be clamped to stroller 10 of FIG. 1 on right front wheel frame 45 and supports 46, for example, or on front wheel frame supports 44 and 45. On accessory 100, the clamps are shown on the upper portion of a tubular member. The clamps in another embodiment may be located at the other portions of support member depending on the frame configuration of the stroller. Another embodiment of an accessory 202 is shown in FIG. 3. The accessory 202 comprises U-shaped brackets 205 and 206 designed to clamp to the outside frame of a stroller, such as frame members 44 and 46 of stroller 10 of FIG. 1. In the embodiment of the accessory 202, the seat attachment member 202 may be slidingly attached to attachment support portion 203 such that the seat attachment member 102 may be moved into a position on the left of the stroller such as position A, a position in a center portion of the stroller such as position B, or a position on the right of the stroller such as position C.

In any embodiment of the invention, the seat attachment portion may be locked into position on the support portion. Either the attachment portion or the support portion may comprise a locking mechanism. The locking mechanism may be a friction locking device or may be an interference locking device such as a pin in a hole or slot, for example.

The clamp or clamps on the accessory may be any clamp or other attachment means for securing the accessory to the stroller. For example, the clamp may be a U-shaped bracket, a U-bolt, a pipe clamp, O-shaped clamp, screw, bolt, other clamping or attachment means. The accessory may be secured to the stroller by one or more clamps and preferably by two or more clamps. Alternatively, the support portions may be integral to the frame of the stroller such that a frame for a double stroller comprises an attachment frame member and a seat attachment portion capable of supporting a seat, wherein the seat attachment portion may be positioned in at least a first position and a second position.

In an alternative embodiment to the embodiments shown in FIG. 2 and FIG. 3, the seat attachment portion may be removably attached to the support portion. In such an embodiment, the support portion of the accessory may comprise multiple attachment points for releasably attaching the seat attachment portion. The seat attachment portion may be removably attached to any of the attachment points of the accessory. In this way, the seat attachment portion may be moved from a first position to a second position on the accessory by detaching the seat attachment portion from one position reattaching it on another position.

An embodiment of the seat attachment member is shown FIG. 4. The seat attachment member may be any configuration capable of supporting the seat on the attachment member of the accessory. The embodiment of the seat attachment member 102 of FIG. 4 comprises a main support 300. The main support 300 comprises a cradle for supporting a central portion of the seat. Another portion of the seat also rests against support bar 301. In this embodiment, support bar 301 may be adjusted to accommodate seats of different shapes and sizes. Support bar 301 may be slid within aperture 303 and locked in place when in the desired position to support a certain seat such as by a set screw or other locking device. The seat is, therefore, supported on two main supports 300 and support bar 301. The seat may be further secured in the seat attachment member 102 by wrapping belts 310 and 311 around the seat and locking the belts in this position with a buckle or other securing means. The sliding connector 307 may be slidingly attached to the attachment members by sliding the attachment member into recesses 302. In this manner, the sliding connector may be slid from the first position to the second position.

Preferably, the seat attachment portion may be selectively positioned in at least a first position and a second position on the attachment member. The first position may be over or on a seat of the double stroller such as in either position 12 or 14 in FIG. 1. When the seat attachment portion of the accessory is in the first position, as defined above, a seat of the double stroller is still fully available for a child to occupy.

Referring again to FIG. 1, the center line of a stroller is a line extending through the center of the stroller as viewed from the front. As used herein, a central portion of the stroller includes an area of the stroller within a distance of 40% of the distance from the center line of the stroller to the outer most part of the stroller. More preferably, the central portion of the stroller includes an area of the stroller within a distance of 20% of the distance from the center line of the stroller to the outer most part of the stroller, and most preferably, the central portion of the stroller includes an area of the stroller within a distance of 10% of the distance from the center line of the stroller to the outer most part of the stroller.

In one embodiment of the invention, the first position may be considered to be a position adjacent or above a position of one of the seats of the double stroller and the second position is substantially in a central portion of the double stroller. In that way, two children could be transported in the double stroller or one child may safely be transported by shifting the seat attachment portion to the second position. The double stroller is more equally balanced and less likely to tip because the weight of the car seat and baby are moved to the central portion of the stroller. This balancing is especially important when the stroller is pushed on uneven terrain or up curbs or other changes in elevation. Thus, in embodiments of the accessory for a double stroller, the seat attachment portion is capable of supporting a seat such that the center of balance of the seat is in a central portion of the stroller.

From the foregoing it will be appreciated that, although specific embodiments of the invention have been described herein for purposes of illustration, various modifications may be made without deviating from the spirit and scope of the invention. Accordingly, the invention is not limited except as by the appended claims.

1. A stroller accessory, comprising:
at least one attachment member and a seat attachment portion capable of supporting a seat, wherein the seat attachment portion may be selectively positioned in at least a first position and a second position on the attachment member.

2. The stroller accessory of claim 1, wherein the seat is a baby carrier.

3. The stroller accessory of claim 1, wherein the seat is an infant car seat

4. The stroller accessory of claim 1, wherein the accessory is capable of being attached to stroller.

5. The stroller accessory of claim 4, wherein the attachment member comprises at least one clamp for attaching the attachment member to a stroller.

6. The stroller accessory of claim 5, wherein the attachment member comprises two clamps for attaching the attachment member to a stroller.

7. The stroller accessory of claim 6, wherein the stroller is a double stroller.

8. The stroller accessory of claim 1, wherein the seat attachment portion is slidingly attached to the attachment member.

9. The stroller accessory of claim 8, wherein the attachment member comprises a tubular member and the seat attachment portion is slidingly attached to the tubular member.

10. The stroller accessory of claim 8, wherein the tubular member has a cross-sectional shape selected from circular, polygonal, square, rectangular, and triangular.

11. The stroller accessory of claim 8, wherein at least one of the seat attachment portion and the attachment member comprise a locking mechanism.

12. The stroller accessory of claim 1, wherein the seat attachment portion is removably attached to the attachment member.

13. The stroller accessory of claim 12, wherein the seat attachment portion is capable of being removably attached in either the first position or the second position.

14. The stroller accessory of claim 7, wherein the first position is adjacent to one of the seats of the double stroller and the second position is substantially in a center portion of the double stroller.

15. A stroller accessory, comprising a seat attachment portion, wherein the seat attachment portion is capable of supporting a seat in at least two positions wherein at least one of the positions is such that the center of balance of the seat is in a center portion of the stroller.

16. The stroller accessory of claim 15, wherein the attachment portion is capable of supporting a seat such that the center of balance of the seat is with the middle 40 percent of the stroller width.

17. The stroller accessory of claim 15, wherein the attachment portion is capable of supporting a seat such that the center of balance of the seat is with the middle 20 percent of the stroller width.

18. A frame for a double stroller, comprising a frame member and a seat attachment portion connected to the frame member wherein the seat attachment portion is capable of supporting a seat and may be positioned in at least a first position and a second position.

19. The stroller accessory of claim 18, wherein the seat is a baby carrier.

20. The stroller accessory of claim 18, wherein the seat is an infant car seat.

21. The stroller accessory of claim 18, wherein the seat attachment portion is slidingly attached to the frame member.

22. The stroller accessory of claim 18, wherein the frame member comprises a tubular member and the seat attachment portion is slidingly attached to the tubular member.

23. The stroller accessory of claim 18, wherein the tubular member has a cross-sectional shape selected from circular, polygonal, square, rectangular, and triangular.

24. The stroller accessory of claim 18, wherein at least one of the seat attachment portion and the attachment member comprise a locking mechanism.

25. The stroller accessory of claim 18, wherein the seat attachment portion is removably attached to the frame member.

26. The stroller accessory of claim 18, wherein the seat attachment portion is capable of being removably attached in either the first position or the second position.
